(19) United States
(12) Patent Application Publication
(10) Pub. No.: US 2025/0093455 A1
(43) Pub. Date: Mar. 20, 2025

(54) GRAPH-BASED FACILITY NAVIGATION USING RF FINGERPRINTS

(71) Applicant: QUALCOMM Incorporated, San Diego, CA (US)

(72) Inventors: Benjamin Tarlow, Cambridge (GB); Murray Jarvis, Cambridge (GB); Nicolas Graube, Cambridge (GB)

(21) Appl. No.: 18/467,443

(22) Filed: Sep. 14, 2023

(51) Int. Cl. G01S 5/02; G01C 21/20; H04W 40/02; H04W 64/00

(52) U.S. Cl. CPC G01S 5/02521; G01C 21/206; H04W 40/02; H04W 64/006

(57) ABSTRACT

This disclosure provides systems, methods, and devices for wireless communication that support guidance of users to particular locations within a facility. In a first aspect, RF fingerprints are determined at locations within the facility based on signal strengths from RF devices, including electronic shelf labels (ESLs). A graph may be determined based on the RF fingerprints. A current location for a user may be determined based on a current RF fingerprint for the user. A route through the graph may be determined through the facility and may be displayed to the user as the user navigates the facility. Other aspects and features are also claimed and described.

### TECHNICAL FIELD

Aspects of the present disclosure relate generally to guidance systems, and more particularly to providing user guidance to particular locations within a facility. Some features may enable and provide improved guidance, including the ability to provide guidance through a facility without having to first determine a map or floor plan of the facility.

### Introduction

Guidance and navigation assistance within facilities such as stores may provide various benefits. Firstly, guidance may aid customers or other users in locating products or departments they need efficiently, thereby saving time and reducing frustration. For individuals with visual impairments or other disabilities, navigational assistance is necessary for accessibility purposes.

Existing systems for indoor guidance may depend on predefined floorplans and defined positions within the facility. Performance of these systems may be adversely affected by changes in floor plan within the facility and by position inaccuracies. For example, various existing techniques like Wi-Fi-based guidance, Bluetooth Low Energy Beacons (BLE), Radio Frequency Identification (RFID), Indoor Positioning Systems (IPS), and the like may depend on different types of positioning equipment, including potentially dedicated positioning equipment. In addition to depending on floorplans within the facility, such systems may be susceptible to performance degradation from various forms of interference, such as physical obstructions, wireless interference, and the like.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

One aspect provides a method that includes determining a plurality of radio frequency (RF) fingerprints at corresponding locations within a facility, the plurality of RF fingerprints indicating signal strengths from RF devices at the corresponding locations, the RF devices including electronic shelf labels (ESLs). The method also includes determining a graph based on the plurality of RF fingerprints. The method also includes receiving a current RF fingerprint for a user within the facility. The method also includes determining, based on the current RF fingerprint, a current location of the user within the graph. The method also includes determining a route to a target product by traversing the graph from the current location to a target location for the target product. The method also includes displaying the route to a user while navigating the facility to the target location.

Another aspect provides a system that includes a memory storing processor-readable code and at least one processor coupled to the memory. The at least one processor may be configured to execute the processor-readable instructions to cause the at least one processor to perform operations that include determining a plurality of radio frequency (RF) fingerprints at corresponding locations within a facility, the plurality of RF fingerprints indicating signal strengths from RF devices at the corresponding locations, the RF devices including electronic shelf labels (ESLs). The operations include determining a graph based on the plurality of RF fingerprints. The operations also include receiving a current RF fingerprint for a user within the facility. The operations also include determining, based on the current RF fingerprint, a current location of the user within the graph. The operations also include determining a route to a target product by traversing the graph from the current location to a target location for the target product. The operations also include displaying the route to a user while navigating the facility to the target location.

A further aspect includes a non-transitory computer-readable medium storing instructions that, when executed by a processor, cause the processor to perform operations that include determining a plurality of radio frequency (RF) fingerprints at corresponding locations within a facility, the plurality of RF fingerprints indicating signal strengths from RF devices at the corresponding locations, the RF devices including electronic shelf labels (ESLs). The operations also include determining a graph based on the plurality of RF fingerprints. The operations also include receiving a current RF fingerprint for a user within the facility. The operations also include determining, based on the current RF fingerprint, a current location of the user within the graph. The operations also include determining a route to a target product by traversing the graph from the current location to a target location for the target product. The operations also include displaying the route to a user while navigating the facility to the target location.

An additional aspect provides a guidance system that includes a plurality of electronic shelf labels (ESLs). The guidance system also includes a computing device configured to perform operations that include determining a plurality of radio frequency (RF) fingerprints at corresponding locations within a facility, the plurality of RF fingerprints indicating signal strengths from the plurality of ESLs. The operations also include determining a graph based on the plurality of RF fingerprints. The operations also include receiving a current RF fingerprint for a user within the facility. The operations also include determining, based on the current RF fingerprint, a current location of the user within the graph. The operations also include determining a route to a target product by traversing the graph from the current location to a target location for the target product. The operations also include displaying the route to a user while navigating the facility to the target location.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 depicts a facility according to one aspect of the present disclosure.

FIGS. 2A-2C depict electronic shelf label (ESL) arrangements according to one aspect of the present disclosure.

FIG. 3 depicts a system for determining and providing guidance within a facility according to one aspect of the present disclosure.

FIGS. 4A-4C depict graphs of RF fingerprints according to one aspect of the present disclosure.

FIG. 5 depicts a method for determining and providing guidance within a facility according to one aspect of the present disclosure.

FIG. 6 depicts a computing device configured to determine and provide guidance within a facility according to one aspect of the present disclosure.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

Various aspects relate generally to providing guidance within facilities. Some aspects more specifically relate to providing guidance to particular products or other items located within a facility, such as a retail store. In some examples, RF signals within a facility may be used to determine one or more fingerprints indicative of various locations within a facility. These fingerprints may then be associated with one or more products or items within the facility and used to provide guidance to a user. For example, the facility may contain one or more electronic shelf labels (ESLs) that provide information for products and items within the facility. The ESLs may correspond to particular products and may themselves be capable of broadcasting and receiving RF signals. Accordingly, RF fingerprints within the facility may be used to identify particular locations associated with particular products. For example, an ESL associated with a product may itself measure an RF fingerprint that accordingly corresponds to the location of the product within the facility. As another example, other measuring devices may themselves detect RF signals broadcast by an ESL corresponding to a particular product. The corresponding location for the product may then be determined based on the measured signal strengths for those signals. Once RF fingerprints are measured, a graph representing the facility may be determined by connecting nodes corresponding to the RF fingerprints with edges. The edges may indicate similarity measures between two RF fingerprints, which may approximate physical proximity within the facility. When the user requests guidance, a route from the user's current location may then be determined by first identifying a current location of the user within the graph and then determining a route through the graph to a target location for the user. In certain instances, the current location may be determined based on a current RF fingerprint for the user and a closest matching node for an RF fingerprint within the graph. The route can be displayed to the user, such as a sequence of products the user can locate to proceed to the target location. Additionally or alternatively, one or more ESLs may be activated to provide guidance (such as audio, vibration, lighting indicators) to the user within the facility according to the route.

Particular aspects of the subject matter described in this disclosure can be implemented to realize one or more of the following potential advantages. In some examples, by constructing a graph based on RF fingerprints, the discussed techniques may be able to determine locations within and provide routes through a facility without requiring a physical map or other indication of a layout of the facility itself. Furthermore, by presenting the guidance to a user using ESLs, these techniques are further able to translate locations within the graph to corresponding physical locations without actually knowing where these locations are within the facility. Furthermore, these techniques may utilize existing hardware within the facility (such as ESLs and other RF devices), which may reduce the need to perform costly equipment upgrades within the facility. Furthermore, by updating the graph at regular intervals, these techniques are able to respond to changes in the RF environment and facility floor plans without needing to be directly informed of these changes.

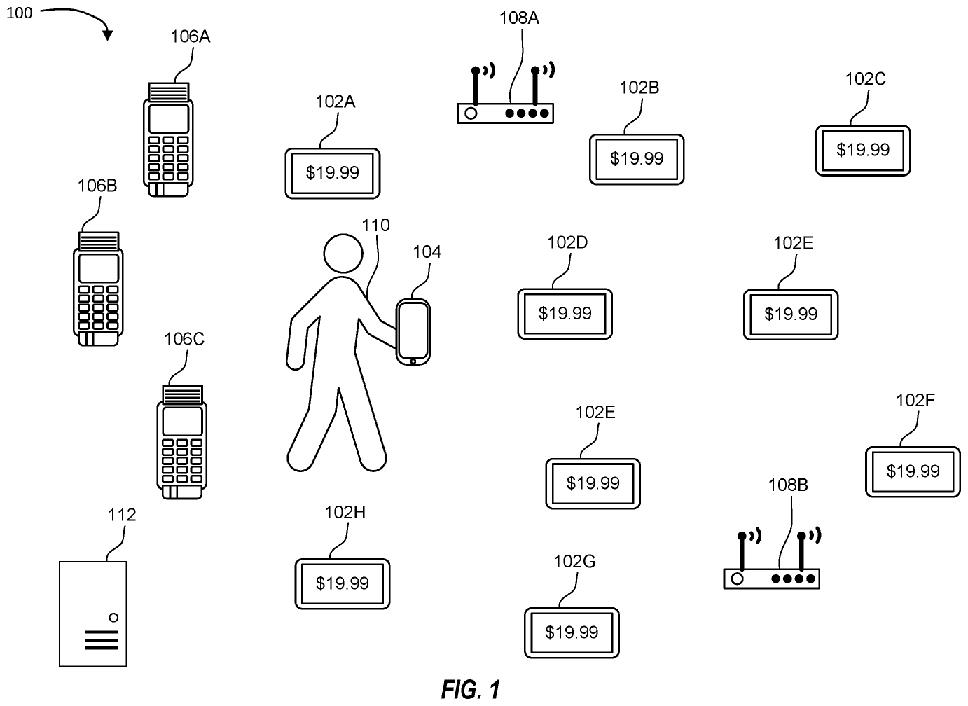

FIG. 1 shows a diagram of an example facility 100 according to one aspect of the present disclosure. The facility 100 includes a user device 104, a computing device 112, and RF devices. The RF devices include ESLs 102A-H, access points 108A-B, and point-of-sale (POS) devices 106A-C. As explained further below, RF measurements may be performed at multiple locations within the facility 100 and may be used to provide guidance to users 110. Specifically, the computing device 112 may receive RF fingerprints from multiple locations within the facility 100 and may use the RF fingerprints to provide guidance to a user 110 associated with a user device 104. For example, guidance may be provided to a desired product or other location within the facility.

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support providing user guidance to particular locations (such as to products or other items) located within a facility. Existing navigation systems within facilities, such as retail stores, rely on having a floorplan and usually a set of axes for describing a user position. Radio transmitters may be used for positioning, such as by using round-trip time, signal strength, range or angle measurements. In such instances, the positions of the transmitters may also need to be known. These systems are thus susceptible to changes in floor plan for the facility and/or to changes in locations of the transmitters. Certain systems attempt to bypass these issues using fingerprinting methods, but even for these, a map and set of axes is required in order to have ground truth values of the survey points used, such as for locations corresponding to particular products.

One solution to this problem is to use RF devices within a facility to determine fingerprints at multiple locations within the facility. These locations can then be associated with particular products or items located within the facility. For example, the RF devices may include one or more electronic shelf labels (ESLs) that correspond to particular products. Corresponding locations for these products may then be identified based on these ESLs. For example, locations may be determined based on RF fingerprints measured by the ESLs themselves. As another example, the corresponding locations may be determined based on signal strength measurements for the ESLs. In one particular implementation, the graph may be determined based on the plurality of RF fingerprints (such as based on similarity measurements between the RF fingerprints) and may be used to provide guidance to users. In particular, a user may request guidance to a particular product or item within the facility. In response, a current RF fingerprint for the user may be identified and used to determine a current location of the user within the graph. A route to the specified product within the graph may be determined by traversing the graph from the current location of the user to a target location for the product, such as a node corresponding to a location of an ESL for that product. The route may then be displayed to a user, such as by a user device, via the ESLs themselves, or combinations thereof.

Particular implementations of the subject matter described in this disclosure may be implemented to realize one or more of the following potential advantages or benefits. In some aspects, the present disclosure provides techniques for guiding users to individual items within a store or other facility without having to physically map or otherwise determine a floorplan of that facility. In addition, by updating the graph at regular intervals, these techniques are able to respond to changes in the RF environment within the facility (such as when RF devices are added, moved, or removed). In certain implementations, these techniques can be implemented without adding additional hardware to the facility, enabling backwards compatibility with existing facility systems.

Returning to FIG. 1, RF devices located within the facility may include one or more ESLs 102A-H. ESLs 102A-H may include digital systems utilized in retail environments that electronically display product pricing and information on store shelves. ESLs 102A-H may include a display that shows current pricing information for associated products. Utilizing communication protocols, ESLs 102A-H may enable real-time, remote price updates across a retail environment. In particular, the information displayed by these labels can be altered through programmatic means, such as by the computing device 112 or another computing device. Any such computing devices may be located within the facility 100 (such as within the same geographic location as the facility 100). In other implementations, the computing device may be remote from the facility 100.

ESLs 102A-H may communicate directly with other computing devices and/or may communicate indirectly (such as via another ESL). For example, the computing device 112 may only have a direct communicative link with a subset of the ESLs 102A-H. Communications with the rest of the ESLs 102A-H may occur indirectly (such as with certain ESLs 102A-H forwarding communications to other ESLs 102A-H).

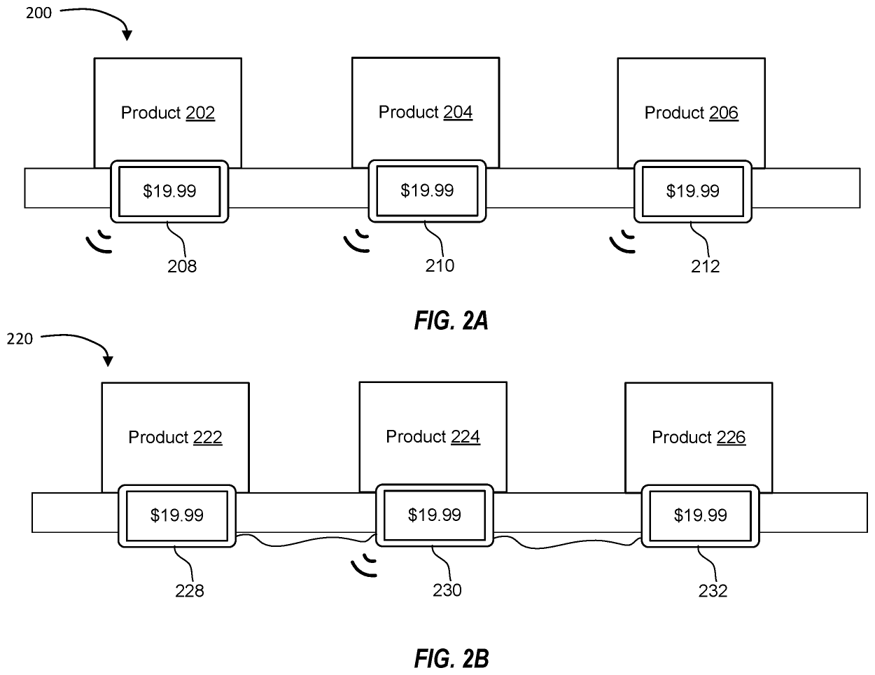

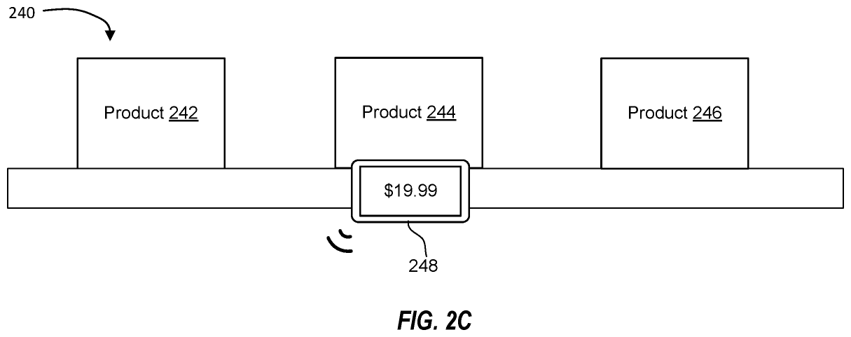

ESLs 102A-H may show product information for one or more products, including product names, identifiers, and pricing information. In certain implementations, ESLs 102A-H may be associated with individual products within a store. In such implementations, an ESL 102A-H may display information for only a single product. For example, FIG. 2A depicts an ESL arrangement 200 in which three different products 202, 204, 206 located on the same shelf are each associated with their own corresponding ESL 208, 210, 212. In the arrangement 200, each ESL 208, 210, 212 may only show product information for its corresponding product 202, 204, 206. In certain such implementations, each ESL 208, 210, 212 may have corresponding wireless communication systems, as shown in FIG. 2A. In additional or alternative implementations, ESLs may share wireless communication systems. For example, FIG. 2B depicts an ESL arrangement 220 in which three ESLs 228, 230, 232 share a common wireless communication system (such as located within the ESL 230). In such instances, the ESLs 228, 232 may receive communications indirectly via the ESL 230 (such as via wired connections between the ESLs 228, 232 and the ESL 230.

In still further implementations, one or more of the ESLs 102A-H may not be associated with any products. For example, a shelf containing an ESL 102A-H may be empty. As another example, ESLs may be included at various locations within the facility 100 (such as on or near information kiosks or help stations within the facility 100) to provide additional RF sources for guidance operations (discussed further below).

Returning to FIG. 1A, in still further implementations, at least a subset of the ESLs 102A-H may be associated with multiple products within a store (such as a shelf containing multiple products) For example, FIG. 2C depicts an ESL arrangement 240 in which three different products 242, 244, 246 located on the same shelf are associated with the same ESL 248. In such instances, the ESL 248 may display information for multiple products, such as by displaying multiple products' information simultaneously, rotating through each products' information sequentially, via an interface to select a particular product, and the like.

The facility 100 may include RF devices other than ESLs. For example, the RF devices may include at least one of an access point (such as a Wi-Fi access point), a cellular device, a base station, a Bluetooth device, a point of sale device, and the like. In particular, FIG. 1A depicts wireless access points 108A-B and POS devices 106A-C. Some non-limiting examples of RF devices include a mobile device, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). An RF device may additionally include a smart energy or security device, a solar panel or solar array, municipal lighting, water, or other infrastructure; industrial automation and enterprise devices, a medical device, a digital audio player (e.g., MP3 player), a camera, a game console, etc.

In certain implementations, the facility 100 may be a retail facility, such as a store containing products for purchase. In additional or alternative implementations, the facility may include other types of facilities, such as warehouses, offices, factories, and the like. In certain such implementations, ESLs (if used) may depict information other than pricing information (such as part identifiers, inventory information, and the like.

In certain implementations, the computing device 112 (such as a computing device 112 located within the facility 100 or physically separate from the facility) may be configured to provide guidance to users located within the facility 100. For example, a user 110 may request guidance to a particular location and/or a particular product via a user device 104. The user device 104 may include a smartphone as shown in FIG. 1A. Other example user devices 110 may include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA), a wearable computing device (such as a smart watch), and the like. The user may request guidance via the user device 104 and/or via another means, such as an information kiosk or help station within the facility 100.

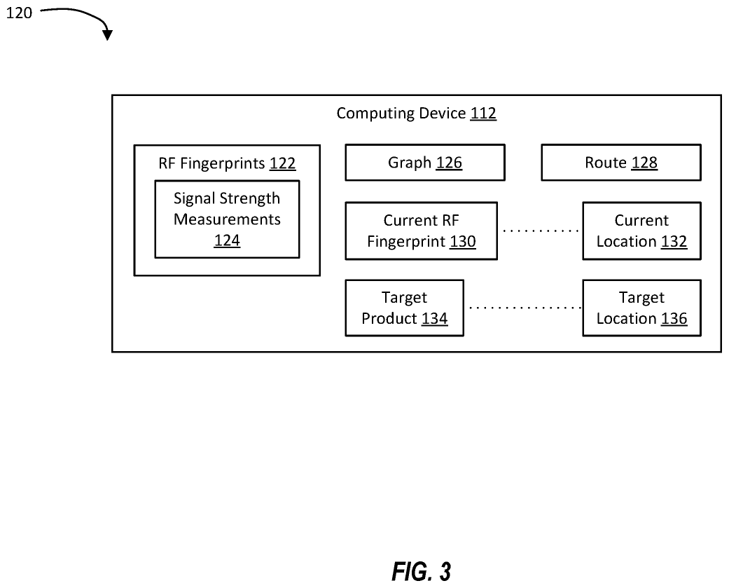

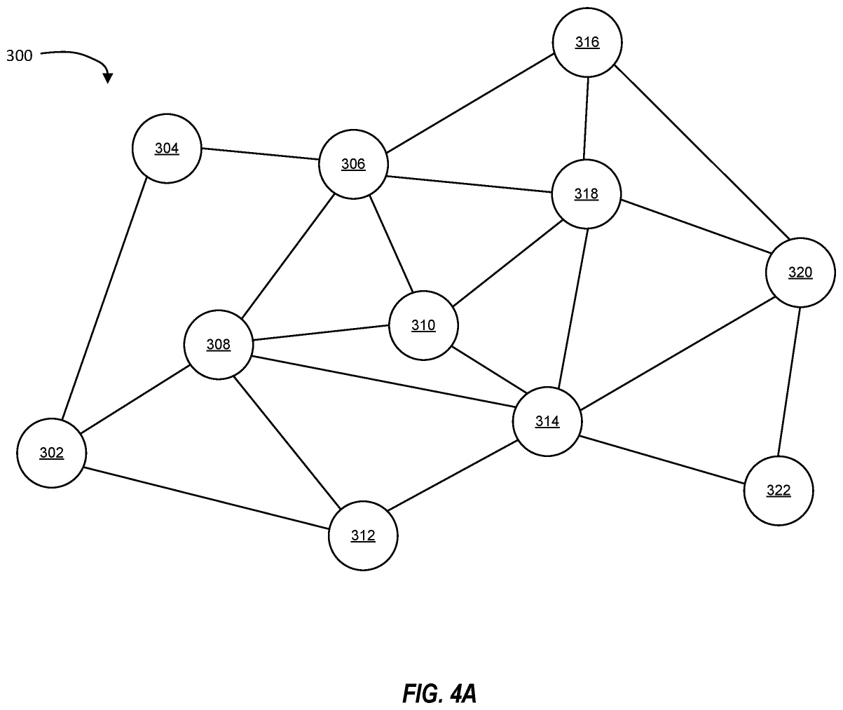

As one particular example, FIG. 3 depicts a system 120 for providing guidance within a facility 100 according to one aspect of the present disclosure. The system 120 includes the computing device 112, which includes RF fingerprints 122, a graph 126, a current RF fingerprint 130, a current location 132, a target product 134, a target location 136, and a route 128. The RF fingerprints 122 include a signal strength measurements 124.

The computing device 112 may be configured to determine a plurality of radio frequency (RF) fingerprints 122 at corresponding locations within a facility (such as a store). The plurality of RF fingerprints 122 may indicating signal strengths from RF devices within the facility. For example, RF fingerprints 122 may be measured at multiple locations within the facility and may indicate signal strength measurements 124 for one or more detected RF devices. The RF devices within the facility 100 may include ESLs 102A-H, as noted above, and may include one or more devices that are not ESLs. In particular, RF devices used for RF fingerprints 122 may be selected from among RF devices located within the facility as devices that remain stationary for long enough periods of time, which may include time periods less than or equal to an updating frequency of the graph 126 (such as at least an hour, a day, a week). In certain implementations, the computing device 112 may maintain a list of included or excluded RF devices or types of RF devices that are used for the RF fingerprints 122.

In certain implementations, the plurality of RF fingerprints 122 may include identifiers of detected ESLs 102A-H and corresponding signal strength measurements 124. For example, the ESLs 102A-H may be configured to broadcast unique identifiers using one or more wireless communication protocols (such as Bluetooth communication protocols, Wi-Fi communication protocols, and the like). In certain configurations, one or more other types of wireless communication protocols may be used by the ESLs 102A-H and/or other RF devices (such as cellular communication protocols, infrared communication protocols, and the like). When determining the plurality of RF fingerprints, ESL IDs and other IDs may be stored in association with a corresponding signal strength value (such as a Received Signal Strength Indicator (RSSI) value). In certain instances, the IDs may be derived from received transmissions.

In certain implementations, the plurality of RF fingerprints 122 are measured by each of at least a subset of the ESLs 102A-H. For example, each of at least a subset of the ESLs 102A-H may measure RSSI information for detected RF devices at their locations within the facility and may transmit the measured RSSI values to the computing device 112.

In additional or alternative implementations, one or more of the RF fingerprints 122 may be measured by a measuring device (such as the computing device 112, another computing device, or combinations thereof) that is not an ESL. For example, a computing device (such as a user device, a specialized RF measurement device, and the like) may measure the RF fingerprints at multiple locations within the facility 100 and may provide the RF fingerprints to the computing device 112. In certain implementations, the measuring device may stop at each of a plurality of locations to measure the RF fingerprints 122. In additional or alternative implementations, the RF fingerprints 122 may be measured on a continuous basis as the measuring device moves through the facility 100. For example, the RF fingerprints 122 may be determined at regular intervals as the measuring devices moves through the facility. As another example, RF fingerprints 122 may be detected (such as by the measuring device, by the computing device 112, or combinations thereof) as locations with peak RSSI values for one or more detected RF devices (such as maximum values for one or more RF devices). As a further example, RF fingerprints 122 may be detected whenever a threshold number of RF devices have measured RSSI values greater than a predetermined threshold (such as greater than −75 dB, −60 dB, −55 dB, and the like).

The computing device 112 may be configured to determine a graph 126 based on the plurality of RF fingerprints. In certain implementations, the graph 126 contains nodes corresponding to each of at least a subset of the RF fingerprints 122. The nodes may be connected by edges. For example, FIG. 3A depicts a graph 300 contain nodes 302-320 connected by edges. For clarity of presentation, the graph 300 does not include edges connecting each of the nodes 302-320. It should be appreciated that, as discussed below, additional edges may be included within the graph 300 beyond those depicted in FIG. 3A. In certain implementations, the edges may be determined according to one or more similarity measures. For example, the edges may be weighted based on similarity measure between corresponding RF fingerprints 122 connected by the edges. Additionally or alternatively, edges may be added to the graph 126 to connect two nodes if the similarity meets a certain threshold. In certain implementations, the graph 126 may be stored as an array, with each row and column corresponding to an RF fingerprint and values stored in particular locations indicating the similarity measure between the two corresponding RF fingerprints.

In certain implementations, similarity measures between two RF fingerprints 122 may be determined based on one or more of common RF devices included within the RF fingerprints 122, similar RSSI measurements for one or more RF devices, rank statistics for RF devices included within the RF fingerprints 122, and the like. As one specific implementation, the similarity measures may be determined as a count of common RF devices between the RF fingerprints. As another example, the similarity measures may be determined as a percentage of detected RF devices that are common between the RF fingerprints. As a further example, the similarity measures may be determined based on a number or percentage of RF devices that have corresponding RSSI measurements within a predetermined threshold of one another (e.g., 5%, 10%, 20%, and the like). In certain implementations, the computing device 112 may consider all detected RF devices in each RF fingerprint 122 when determining the similarity measures. In additional or alternative implementations, the computing device 112 may consider only a subset of the detected RF devices (such as the RF devices with the five highest RSSIs, 10 highest RSSIs, 20 highest RSSIs, and the like). In certain implementations, higher similarity measures may indicate a greater similarity between corresponding RF fingerprints 122. In additional or alternative implementations, lower similarity measures may indicate greater similarity between corresponding RF fingerprints 122.

Based on this disclosure, one skilled in the art will appreciate that various scoring techniques may be used in addition to or alternatively to those discussed herein. All such techniques are considered within the scope of the present disclosure. Furthermore, one skilled in the art will appreciate that various implementations of the graph 126 may be used in addition to or alternatively to those discussed herein. All such techniques are also considered the scope of the present disclosure.

In certain implementations, a map of the facility 100 containing the ESLs 102A-H is not necessarily required to create the graph 126. Stated differently, physical locations may not be known for the corresponding locations of the RF fingerprints 122. Instead, the corresponding locations for the RF fingerprints 122 may be identified as locations within the graph 126 (discussed below), even though the locations also correspond to physical locations within the facility 100. As explained further below, even without knowing the physical locations, it may be still possible to provide guidance through the facility 100.

The computing device 112 may be configured to determine a current RF fingerprint 130 for a user within the facility. In certain implementations, the current RF fingerprint 130 may be measured at least in part by a user device 104 associated with a user 110 (such as a user requesting guidance). In such instances, RF signal measurements and/or the current RF fingerprint 130 may be received from the user device 104. In certain implementations, the current RF fingerprint may be determined based on the same or similar information captured for the plurality of RF fingerprints 122. For example, the current RF fingerprint may include identifiers and signal strength measurements 124 for RF devices detected by the user device 104. In certain implementations, the current RF fingerprint 130 may be determined after the graph 126 is created. For example, the graph 126 may be created, updated, or combinations thereof at regular intervals (such as hourly, daily, weekly, monthly). In such instances, the current RF fingerprint may be determined or received after creating or updating the graph 126.

The computing device 112 may be configured to determine, based on the current RF fingerprint 130, a current location 132 of the user within the graph 126. In certain implementations, determining the current location 132 of the user 110 includes determining, as the current location 132 of the user, a closest matching node for the current RF fingerprint 130 within the graph 126. For example, similarity measures may be computed between the current RF fingerprints 130 and one or more of the RF fingerprints 122 used to create the graph. The similarity measures may be computed using the same or similar techniques as those used to determine edges of the graph 126. In such instances, the closest matching node may be identified as a node within the graph 126 with the similarity measure indicating the greatest similarity (such as the highest similarity measure value, the lowest similarity measure depending on the implementation of the similarity measure). In certain implementations, signal measurements for the current RF fingerprint 130 RF fingerprints 1 to 2 may be normalized (such as based on the highest our society value measured) prior to determining the similarity measures and identifying the closest matching node.

The computing device 112 may be configured to determine a route 128 to a target product 134. For example, the route 128 may traverse the graph 126 from the current location 132 to a target location 136. The target location 136 may be a location for the target product 134. In certain implementations, the target product 134 may be selected or otherwise received from a user 110, such as via an application running on the user device 104. As one example, the user 110 may request and receive guidance via an application on the user device 104. The application may be associated with or otherwise contain information regarding the facility 100. As one specific example, the application may include inventory information or a store, including products available for purchase within the store. The user 110 may search for and identify a target product 134 within the application and may request, via the application, guidance to the target product 134.

In certain implementations, the route 128 may be determined to contain a sequence of nodes within the graph 126 connecting the closest matching node to the target location 136. In certain implementations, the target location 136 may be an ESL 102A-H that corresponds to the target product 134 (such as an ESL that corresponds to one or more products that include the target product 134). For example, the target location 136 may be a node within the graph 126 that corresponds to an RF fingerprint 122 measured by an ESL 102A-H for the target product 134. As another example, the target location may be a node within the graph 126 that corresponds to an RF fingerprint 122 with the highest RSSI value for an ESL 102A-H for the target product 134.

In certain implementations, one or more graph traversal techniques may be used to identify the route 128 from the current location 132 to the target location 136. For example, the route 128 may be determined to traverse the graph 126 from the current location 132 to a target location 136 with a fewest number of nodes. In certain such implementations, edges included in the route 128 may be selected to meet a predetermined similarity requirement (i.e., a minimum similarity measure threshold, a maximum similarity measure threshold, depending on the implementation of the similarity measure). Such implementations may result in routes that are simpler. As one specific example, FIG. 3B depicts a route 330 through the graph 300 from a current location at node 302 to a target location at 320. The route 330 is selected to traverse the fewest number of nodes (i.e., 3 total edges traversed from node 302 to node 312, to node 314, to node 320). In still further implementations, the route 128 may be determined to traverse the graph 126 from the current location 132 to the target location 136 while optimizing the average similarity measure for edges included in the route 128 (such as maximizing the average similarity measure, minimizing the average similarity measure, depending on the implementation of the similarity measure). Such implementations may result in routes that proceed between products that are closer together, which may be easier for users to follow. As one specific example, FIG. 3C depicts a route 340 between nodes 302, 320 that differs from, and includes more nodes than, the route 330, extending from node 302 to node 308, to node 310, to node 314, to node 318, to node 320. The route 340 may maximize the similarity between adjacent nodes along the route, resulting in more nodes included when compared to route 330. One skilled in the art will appreciate that the computing device 112 may consider other factors when determining or selecting between routes. For example, in addition to the strategies discussed above, routes 128 may be selected based on a maximum number of nodes, a minimum threshold level of similarity for selected edges, and combinations thereof.

The computing device 112 may be configured to display the route 128 to a user while navigating the store to the target location 136. For example, the route 128 may be displayed to the user 110 via the user device 104. In certain implementations, the route 128 may be displayed as a series of products the user can travel to in order to arrive at the target product 134. In certain implementations, displaying the route 128 may include displaying a sequence of products along the route 128. For example, the user device 104 may display the series of products, the next product the user 110 should travel to, or combinations thereof. In additional or alternative implementations, displaying the route 128 may include displaying a progress indicator on a mobile device associated with the user. For example, the user device 104 may display a progress indicator based on a proportion of nodes along the route that the user has travelled to. As another example, the user device 104 may display a hot/cold indicator based on whether the user is getting closer to or further from the target product 134. In still further implementations, displaying the route 128 may include illuminating a sequence of ESLs 102A-H along the route 128, such as ESLs corresponding to the sequence of products along the route 128. In certain implementations, displaying the route 128 may indicate a certain section of the store that the user should travel to before receiving further guidance, such as a particular location in the store (“back of the store”), a particular department (“Home Goods”), or a particular aisle (“A13”). The section of the store may be identified based on a product taxonomy for the facility, such as by identifying metadata for the target product indicating an expected section of the store. When the user arrives at the section, more detailed guidance may be provided, as described above.

The computing device 112 may be configured to monitor the user's progress along the route 128. For example, updated locations may be determined for the user at regular intervals by measuring new, current RF fingerprints 130 using the user device 104. The updated location may be compared to the route 128 to determine the user's progress along the route 128. In certain implementations, the computing device 112 may determine updated routes using the techniques discussed above (such as between an updated location and the target location 136). In certain implementations, if the user deviates from the route 128 (such as by a certain distance, for a certain period of time), an alert may be issued to the facility, such as a manager or other personnel of the facility. The alert may identify the user, the target product, the user's current location, or combinations thereof.

In certain implementations, the computing device 112 may be configured to update the graph 126 at regular intervals. For example, the computing device 112 may update the graph 126 may determining or receiving updated RF fingerprints 122 (such as by querying the ESLs A-H for updated RF fingerprints 122, triggering a new measurement procedure by a measuring device, and the like). An updated graph 126 for the facility may then be determined using the techniques discussed above, based on the updated RF fingerprints. In various implementations, the graph 126 may be updated every hour, every day, every week, every month, and the like.

As described with reference to FIG. 3, the present disclosure provides techniques for providing user's guidance to individual items within a store or other facility without having to map that facility. In addition, by updating the graph at regular intervals, these techniques are able to respond to changes in the RF environment within the facility (such as when RF devices are added, moved, or removed). In certain implementations, these techniques can be implemented without adding additional hardware to the facility, enabling backwards compatibility with existing facility systems.

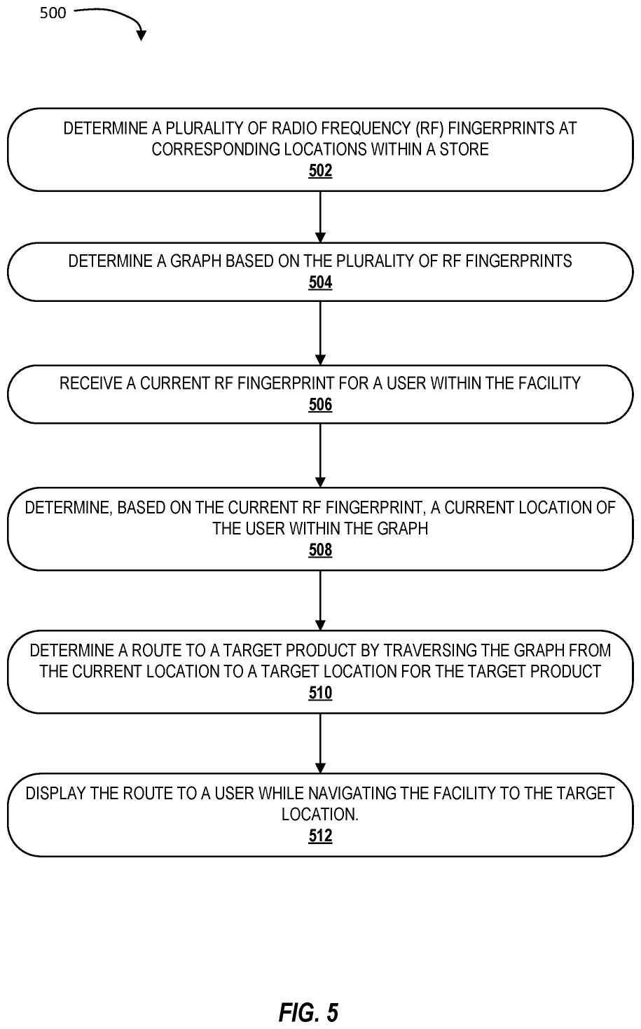

FIG. 5 depicts a method for providing user guidance within a facility according to one aspect of the present disclosure. The method 500 may be implemented on a computer system, such as the system 120. For example, the method 500 may be implemented by the computing device 112. The method 500 may also be implemented by a set of instructions stored on a computer readable medium that, when executed by a processor, cause the computing device to perform the method 500. Although the examples below are described with reference to the flowchart illustrated in FIG. 5, many other methods of performing the acts associated with FIG. 5 may be used. For example, the order of some of the blocks may be changed, certain blocks may be combined with other blocks, one or more of the blocks may be repeated, and some of the blocks may be optional.

The method 500 includes determining a plurality of RF fingerprints 122 at corresponding locations within a facility, the plurality of RF fingerprints 122 indicating signal strengths from RF devices, the RF devices including ESLs 102A-H (block 502). For example, the computing device 112 may determine a plurality of radio frequency (RF) fingerprints at corresponding locations within a facility 100. In certain implementations, the plurality of RF fingerprints 122 are measured by each of at least a subset of the ESLs 102A-H. In additional or alternative implementations, the plurality of RF fingerprints 122 are measured by at least one measuring device separate from the RF devices.

The method 500 includes determining a graph 126 based on the plurality of RF fingerprints (block 504). For example, the computing device 112 may determine a graph 126 based on the plurality of RF fingerprints. In certain implementations, the graph 126 contains nodes corresponding to the RF fingerprints and edges connecting the nodes based on similarity measures between corresponding RF fingerprints 122.

The method 500 includes determining a current RF fingerprint 130 for a user 110 within the facility (block 506). For example, the computing device 112 may determine a current RF fingerprint 130 for a user within the facility. In certain implementations, the current RF fingerprint may be measured and received from a user device 104 associated with the user. In certain implementations, the current RF fingerprint may be determined based on the same or similar information captured for the plurality of RF fingerprints. For example, the current RF fingerprint may include IDs and signal strength measurements 124 for detected RF devices.

The method 500 includes determining, based on the current RF fingerprint 130, a current location 132 of the user within the graph 126 (block 508). For example, the computing device 112 may determine, based on the current RF fingerprint, a current location 132 of the user within the graph 126. In certain implementations, determining the current location 132 of the user includes determining, as the current location 132 of the user, a closest matching node for the current RF fingerprint within the graph 126.

The method 500 includes determining a route 128 to a target product 134 by traversing the graph 126 from the current location 132 to a target location 136 for the target product 134 (block 510). For example, the computing device 112 may determine a route 128 to a target product 134 by traversing the graph 126 from the current location 132 to a target location 136 for the target product 134. In certain implementations, the target product 134 may be selected or otherwise received from a user, such as via an application running on the user device 104. In certain implementations, the route 128 may be determined to contain a sequence of nodes within the graph 126 connecting the closest matching node to the target location 136. In certain implementations, the target location 136 may be an ESL corresponding to the target product 134. In certain implementations, the route 128 may be determined to traverse the graph 126 from the current location 132 to a target location 136 with a fewest number of nodes, where edges of the route 128 meet a predetermined similarity requirement. In certain implementations, the route 128 may be determined to traverse the graph 126 from the current location 132 to the target location 136 while optimizing the average similarity measure for edges included in the route 128.

The method 500 includes displaying the route 128 to a user while navigating the store to the target location 136 (block 512). For example, the computing device 112 may display the route 128 to a user while navigating the store to the target location 136. In certain implementations, displaying the route 128 may include at least one of illuminating a sequence of ESLs 102A-H along the route 128, displaying a progress indicator on a mobile device associated with the user, displaying a sequence of products along the route 128, or a combination thereof.

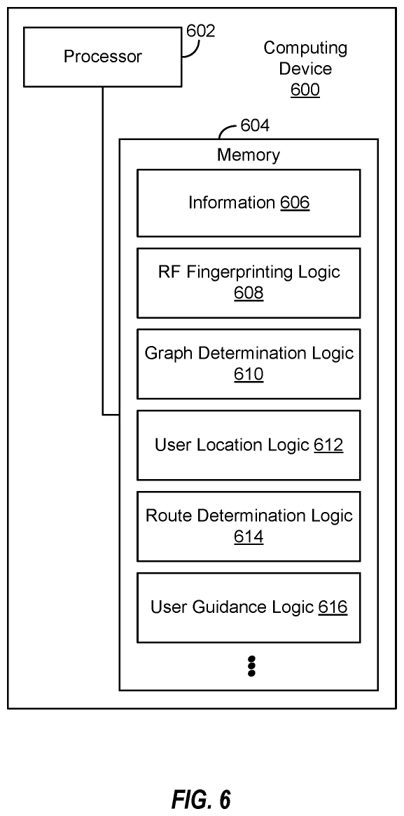

FIG. 6 is a block diagram of an example computing device 600 that supports guidance through facilities according to one or more aspects. The computing device 600 may be configured to perform operations, including the blocks of a process described with reference to FIG. 5. In some implementations, the computing device 600 includes the structure, hardware, and components shown and described with reference to the computing device 112 of FIGS. 1 and 3. The computing device 600 includes memory 602 and a processor 604. The memory 602 includes instructions, which may be executed by the processor 604 to perform one or more functions of the computing device 600. In particular, the memory 602 includes RF fingerprinting logic 608, graph determination logic 610, user location logic 612, route determination logic 614, and user guidance logic 616.

The RF fingerprinting logic 608 may be configured to determine a plurality of radio frequency (RF) fingerprints at corresponding locations within a facility. In certain implementations, the plurality of RF fingerprints are measured by each of at least a subset of ESLs. In additional or alternative implementations, the plurality of RF fingerprints are measured by at least one measuring device separate from the RF devices.

The graph determination logic 610 may be configured to determine a graph based on the plurality of RF fingerprints. In certain implementations, the graph contains nodes corresponding to the RF fingerprints and edges connecting the nodes based on similarity measures between corresponding RF fingerprints.

The user location logic 612 may be configured to determine a current RF fingerprint for a user within the facility. In certain implementations, the current RF fingerprint may be measured and received from a user device associated with the user. In certain implementations, the current RF fingerprint may be determined based on the same or similar information captured for the plurality of RF fingerprints. For example, the current RF fingerprint may include IDs and signal strength measurements for detected RF devices.

The user location logic 612 may also be configured to determine, based on the current RF fingerprint, a current location of the user within the graph. In certain implementations, determining the current location of the user includes determining, as the current location of the user, a closest matching node for the current RF fingerprint within the graph.

The route determination logic 614 may be configured to determine a route to a target product by traversing the graph from the current location to a target location for the target product. In certain implementations, the target product may be selected or otherwise received from a user, such as via an application running on the user device. In certain implementations, the route may be determined to contain a sequence of nodes within the graph connecting the closest matching node to the target location. In certain implementations, the target location may be an ESL corresponding to the target product. In certain implementations, the route may be determined to traverse the graph from the current location to a target location with a fewest number of nodes, where edges of the route meet a predetermined similarity requirement. In certain implementations, the route may be determined to traverse the graph from the current location to the target location while optimizing the average similarity measure for edges included in the route.

The user guidance logic 616 may be configured to display the route to a user while navigating the store to the target location. In certain implementations, displaying the route may include at least one of illuminating a sequence of ESLs along the route, displaying a progress indicator on a mobile device associated with the user, displaying a sequence of products along the route, or a combination thereof.

In one or more aspects, techniques for supporting navigation through facilities may include additional aspects, such as any single aspect or any combination of aspects described below or in connection with one or more other processes or devices described elsewhere herein. A first aspect provides a method that includes determining a plurality of radio frequency (RF) fingerprints at corresponding locations within a facility, the plurality of RF fingerprints indicating signal strengths from RF devices at the corresponding locations, the RF devices including electronic shelf labels (ESLs). The method also includes determining a graph based on the plurality of RF fingerprints. The method also includes receiving a current RF fingerprint for a user within the facility. The method also includes determining, based on the current RF fingerprint, a current location of the user within the graph. The method also includes determining a route to a target product by traversing the graph from the current location to a target location for the target product. The method also includes displaying the route to a user while navigating the facility to the target location.

In a second aspect, in combination with the first aspect, the graph contains nodes corresponding to the RF fingerprints and edges connecting the nodes based on similarity measures between corresponding RF fingerprints.

In a third aspect, in combination with the second aspect, determining the current location of the user may include determining, as the current location of the user, a closest matching node for the current RF fingerprint within the graph.

In a fourth aspect, in combination with the third aspect, the route is determined to contain a sequence of nodes within the graph connecting the closest matching node to the target location.

In a fifth aspect, in combination with the fourth aspect, the route is determined to traverse the graph from the current location to a target location with the fewest number of nodes, where edges connecting the sequence of nodes within the route meet a predetermined similarity requirement.

In a sixth aspect, in combination with one or more of the second aspect through the fifth aspect, the route is determined to traverse the graph from the current location to the target location while optimizing an average similarity measure for edges included in the route.

In a seventh aspect, in combination with one or more of the first aspect through the sixth aspect, the target location is an ESL corresponding to the target product.

In an eighth aspect, in combination with one or more of the first aspect through the seventh aspect, the plurality of RF fingerprints are measured by each of at least a subset of the ESLs.

In a ninth aspect, in combination with one or more of the first aspect through the eighth aspect, the plurality of RF fingerprints are identified based on maximum values of RF signals measured while moving through the facility.

In a tenth aspect, in combination with one or more of the first aspect through the ninth aspect, displaying the route includes (i) illuminating a sequence of ESLs along the route, (ii) displaying a progress indicator on a mobile device associated with the user, (iii) displaying a sequence of products along the route, or (iv) a combination thereof.

An eleventh aspect provides a system that includes a memory storing processor-readable code and at least one processor coupled to the memory. The at least one processor may be configured to execute the processor-readable instructions to cause the at least one processor to perform operations that include determining a plurality of radio frequency (RF) fingerprints at corresponding locations within a facility, the plurality of RF fingerprints indicating signal strengths from RF devices at the corresponding locations, the RF devices including electronic shelf labels (ESLs). The operations include determining a graph based on the plurality of RF fingerprints. The operations also include receiving a current RF fingerprint for a user within the facility. The operations also include determining, based on the current RF fingerprint, a current location of the user within the graph. The operations also include determining a route to a target product by traversing the graph from the current location to a target location for the target product. The operations also include displaying the route to a user while navigating the facility to the target location.

Additionally, the apparatus may perform or operate according to one or more aspects as described below. In some implementations, the apparatus includes a wireless device, such as a user device. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a twelfth aspect, in combination with the eleventh aspect, the graph contains nodes corresponding to the RF fingerprints and edges connecting the nodes based on similarity measures between corresponding RF fingerprints.

In a thirteenth aspect, in combination with the twelfth aspect, determining the current location of the user may include determining, as the current location of the user, a closest matching node for the current RF fingerprint within the graph.

In a fourteenth aspect, in combination with the thirteenth aspect, the route is determined to contain a sequence of nodes within the graph connecting the closest matching node to the target location.

In a fifteenth aspect, in combination with the fourteenth aspect, the route is determined to traverse the graph from the current location to a target location with the fewest number of nodes, where edges connecting the sequence of nodes within the route meet a predetermined similarity requirement.

In a sixteenth aspect, in combination with one or more of the twelfth aspect through the fifteenth aspect, the route is determined to traverse the graph from the current location to the target location while optimizing an average similarity measure for edges included in the route.

In a seventeenth aspect, in combination with one or more of the eleventh aspect through the sixteenth aspect, the target location is an ESL corresponding to the target product.

In an eighteenth aspect, in combination with one or more of the eleventh aspect through the seventeenth aspect, the plurality of RF fingerprints are measured by each of at least a subset of the ESLs.

In a nineteenth aspect, in combination with one or more of the eleventh aspect through the eighteenth aspect, the plurality of RF fingerprints are identified based on maximum values of RF signals measured while moving through the facility.

In a twentieth aspect, in combination with one or more of the eleventh aspect through the nineteenth aspect, displaying the route includes (i) illuminating a sequence of ESLs along the route, (ii) displaying a progress indicator on a mobile device associated with the user, (iii) displaying a sequence of products along the route, or (iv) a combination thereof.

A twenty-first aspect includes a non-transitory computer-readable medium storing instructions that, when executed by a processor, cause the processor to perform operations that include determining a plurality of radio frequency (RF) fingerprints at corresponding locations within a facility, the plurality of RF fingerprints indicating signal strengths from RF devices at the corresponding locations, the RF devices including electronic shelf labels (ESLs). The operations also include determining a graph based on the plurality of RF fingerprints. The operations also include receiving a current RF fingerprint for a user within the facility. The operations also include determining, based on the current RF fingerprint, a current location of the user within the graph. The operations also include determining a route to a target product by traversing the graph from the current location to a target location for the target product. The operations also include displaying the route to a user while navigating the facility to the target location.

In a twenty-second aspect, in combination with the twenty-first aspect, the graph contains nodes corresponding to the RF fingerprints and edges connecting the nodes based on similarity measures between corresponding RF fingerprints.

In a twenty-third aspect, in combination with the twenty-second aspect, determining the current location of the user may include determining, as the current location of the user, a closest matching node for the current RF fingerprint within the graph.

In a twenty-fourth aspect, in combination with the twenty-third aspect, the route is determined to contain a sequence of nodes within the graph connecting the closest matching node to the target location.

In a twenty-fifth aspect, in combination with the twenty-fourth aspect, the route is determined to traverse the graph from the current location to a target location with the fewest number of nodes, where edges connecting the sequence of nodes within the route meet a predetermined similarity requirement.

A twenty-sixth aspect provides a guidance system that includes a plurality of electronic shelf labels (ESLs). The guidance system also includes a computing device configured to perform operations that include determining a plurality of radio frequency (RF) fingerprints at corresponding locations within a facility, the plurality of RF fingerprints indicating signal strengths from the plurality of ESLs. The operations also include determining a graph based on the plurality of RF fingerprints. The operations also include receiving a current RF fingerprint for a user within the facility. The operations also include determining, based on the current RF fingerprint, a current location of the user within the graph. The operations also include determining a route to a target product by traversing the graph from the current location to a target location for the target product. The operations also include displaying the route to a user while navigating the facility to the target location.

In a twenty-seventh aspect, in combination with the twenty-sixth aspect, the graph contains nodes corresponding to the RF fingerprints and edges connecting the nodes based on similarity measures between corresponding RF fingerprints.

In a twenty-eighth aspect, in combination with the twenty-seventh aspect, determining the current location of the user may include determining, as the current location of the user, a closest matching node for the current RF fingerprint within the graph.

In a twenty-ninth aspect, in combination with the twenty-eighth aspect, the route is determined to contain a sequence of nodes within the graph connecting the closest matching node to the target location.

In a thirtieth aspect, in combination with the twenty-ninth aspect, the route is determined to traverse the graph from the current location to a target location with the fewest number of nodes, where edges connecting the sequence of nodes within the route meet a predetermined similarity requirement.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

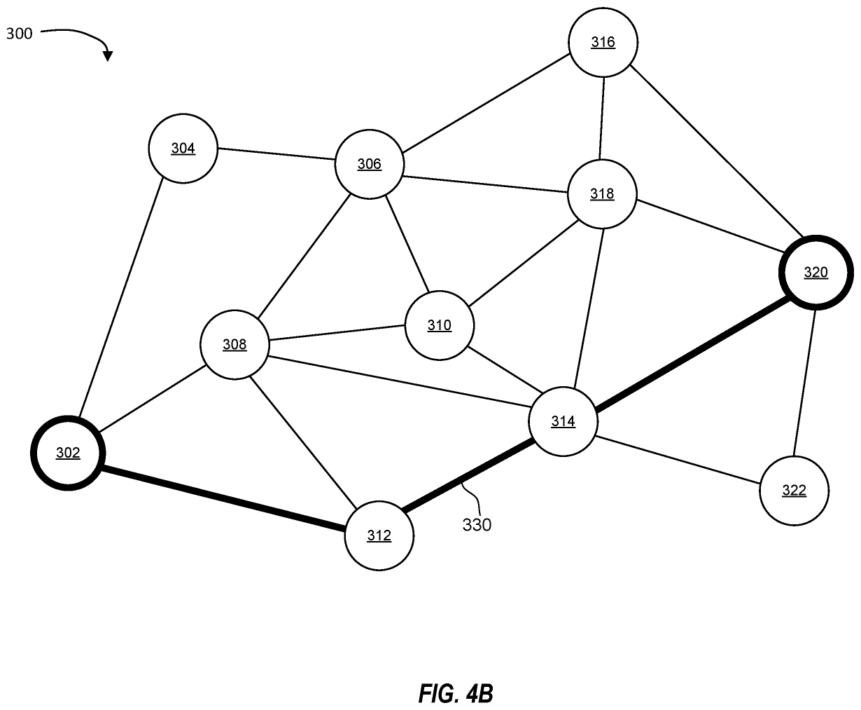

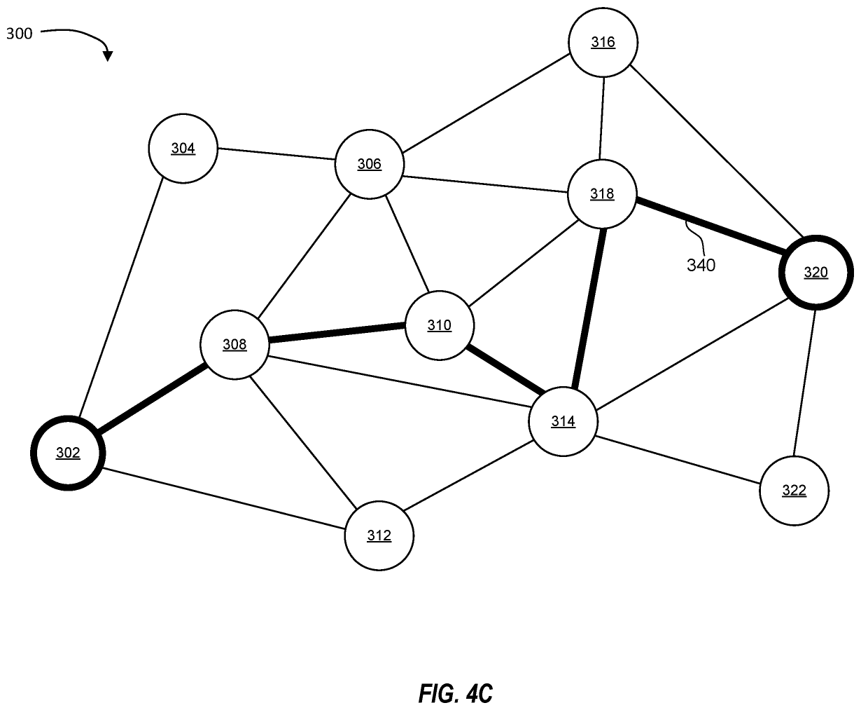

Components, the functional blocks, and the modules described herein with respect to FIGS. 1-4 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method comprising:
determining a plurality of radio frequency (RF) fingerprints at corresponding locations within a facility, the plurality of RF fingerprints indicating signal strengths from RF devices at the corresponding locations, the RF devices including electronic shelf labels (ESLs);
determining a graph based on the plurality of RF fingerprints;
receiving a current RF fingerprint for a user within the facility;
determining, based on the current RF fingerprint, a current location of the user within the graph;
determining a route to a target product by traversing the graph from the current location to a target location for the target product; and
displaying the route to a user while navigating the facility to the target location.

2. The method of claim 1, wherein the graph contains nodes corresponding to the RF fingerprints and edges connecting the nodes based on similarity measures between corresponding RF fingerprints.

3. The method of claim 2, wherein determining the current location of the user comprises determining, as the current location of the user, a closest matching node for the current RF fingerprint within the graph.

4. The method of claim 3, wherein the route is determined to contain a sequence of nodes within the graph connecting the closest matching node to the target location.

5. The method of claim 4, wherein the route is determined to traverse the graph from the current location to a target location with the fewest number of nodes, where edges connecting the sequence of nodes within the route meet a predetermined similarity requirement.

6. The method of claim 2, wherein the route is determined to traverse the graph from the current location to the target location while optimizing an average similarity measure for edges included in the route.

7. The method of claim 1, wherein the target location is an ESL corresponding to the target product.

8. The method of claim 1, wherein the plurality of RF fingerprints are measured by each of at least a subset of the ESLs.

9. The method of claim 1, wherein the plurality of RF fingerprints are determined based on maximum values of RF signals measured while moving through the facility.

10. The method of claim 1, wherein displaying the route includes (i) illuminating a sequence of ESLs along the route, (ii) displaying a progress indicator on a mobile device associated with the user, (iii) displaying a sequence of products along the route, or (iv) a combination thereof.

11. A system comprising:
a memory storing processor-readable code; and
at least one processor coupled to the memory, the at least one processor configured to execute the processor-readable instructions to cause the at least one processor to perform operations comprising:
determining a plurality of radio frequency (RF) fingerprints at corresponding locations within a facility, the plurality of RF fingerprints indicating signal strengths from RF devices at the corresponding locations, the RF devices including electronic shelf labels (ESLs);
determining a graph based on the plurality of RF fingerprints;
receiving a current RF fingerprint for a user within the facility;
determining, based on the current RF fingerprint, a current location of the user within the graph;
determining a route to a target product by traversing the graph from the current location to a target location for the target product; and
displaying the route to a user while navigating the facility to the target location.

12. The system of claim 11, wherein the graph contains nodes corresponding to the RF fingerprints and edges connecting the nodes based on similarity measures between corresponding RF fingerprints.

13. The system of claim 12, wherein determining the current location of the user comprises determining, as the current location of the user, a closest matching node for the current RF fingerprint within the graph.

14. The system of claim 13, wherein the route is determined to contain a sequence of nodes within the graph connecting the closest matching node to the target location.

15. The system of claim 14, wherein the route is determined to traverse the graph from the current location to a target location with the fewest number of nodes, where edges connecting the sequence of nodes within the route meet a predetermined similarity requirement.

16. The system of claim 12, wherein the route is determined to traverse the graph from the current location to the target location while optimizing an average similarity measure for edges included in the route.

17. The system of claim 11, wherein the target location is an ESL corresponding to the target product.

18. The system of claim 11, wherein the plurality of RF fingerprints are measured by each of at least a subset of the ESLs.

19. The system of claim 11, wherein the plurality of RF fingerprints are determined based on maximum values of RF signals measured while moving through the facility.

20. The system of claim 11, wherein displaying the route includes (i) illuminating a sequence of ESLs along the route, (ii) displaying a progress indicator on a mobile device associated with the user, (iii) displaying a sequence of products along the route, or (iv) a combination thereof.

21. A non-transitory computer-readable medium storing instructions that, when executed by a processor, cause the processor to perform operations comprising:
determining a plurality of radio frequency (RF) fingerprints at corresponding locations within a facility, the plurality of RF fingerprints indicating signal strengths from RF devices at the corresponding locations, the RF devices including electronic shelf labels (ESLs);
determining a graph based on the plurality of RF fingerprints;
receiving a current RF fingerprint for a user within the facility;
determining, based on the current RF fingerprint, a current location of the user within the graph;
determining a route to a target product by traversing the graph from the current location to a target location for the target product; and
displaying the route to a user while navigating the facility to the target location.

22. The non-transitory computer-readable medium of claim 21, wherein the graph contains nodes corresponding to the RF fingerprints and edges connecting the nodes based on similarity measures between corresponding RF fingerprints.

23. The non-transitory computer-readable medium of claim 22, wherein determining the current location of the user comprises determining, as the current location of the user, a closest matching node for the current RF fingerprint within the graph.

24. The non-transitory computer-readable medium of claim 23, wherein the route is determined to contain a sequence of nodes within the graph connecting the closest matching node to the target location.

25. The non-transitory computer-readable medium of claim 24, wherein the route is determined to traverse the graph from the current location to a target location with the fewest number of nodes, where edges connecting the sequence of nodes within the route meet a predetermined similarity requirement.

26. A guidance system comprising:
a plurality of electronic shelf labels (ESLs); and
a computing device configured to perform operations comprising:
determining a plurality of radio frequency (RF) fingerprints at corresponding locations within a facility, the plurality of RF fingerprints indicating signal strengths from the plurality of ESLs;
determining a graph based on the plurality of RF fingerprints;
receiving a current RF fingerprint for a user within the facility;
determining, based on the current RF fingerprint, a current location of the user within the graph;
determining a route to a target product by traversing the graph from the current location to a target location for the target product; and
displaying the route to a user while navigating the facility to the target location.

27. The guidance system of claim 26, wherein the graph contains nodes corresponding to the RF fingerprints and edges connecting the nodes based on similarity measures between corresponding RF fingerprints.

28. The guidance system of claim 27, wherein determining the current location of the user comprises determining, as the current location of the user, a closest matching node for the current RF fingerprint within the graph.

29. The guidance system of claim 28, wherein the route is determined to contain a sequence of nodes within the graph connecting the closest matching node to the target location.

30. The guidance system of claim 29, wherein the route is determined to traverse the graph from the current location to a target location with the fewest number of nodes, where edges connecting the sequence of nodes within the route meet a predetermined similarity requirement.
